(19) United States
(12) Patent Application Publication
(10) Pub. No.: US 2008/0029614 A1
(43) Pub. Date: Feb. 7, 2008

(54) Mist-Spraying Apparatus

(75) Inventor: David James Dore, Derbyshire (GB)

Correspondence Address: EGBERT LAW OFFICES, 412 MAIN STREET, 7TH FLOOR, HOUSTON, TX, 77002, US

(73) Assignee: QUILL INTERNATIONAL INDUSTRIES OLC, DERBYSHIRE (GB)

(21) Appl. No.: 10/580,705

(22) PCT Filed: Nov. 17, 2004
(86) PCT No.: PCT/GB04/04799

§ 371 Date: Mar. 6, 2007

(30) Foreign Application Priority Data
Dec. 3, 2003 (GB) 0328003.9

(51) Int. Cl. B60H 3/02

(52) U.S. Cl. 239/8

(57) ABSTRACT

A mist-spraying apparatus primarily but not exclusively for use in an enclosed space includes an air-blowing mechanism, a spraying mechanism and a control mechanism. The air-blowing mechanism defines an outlet conduit through which air can be blown and an inlet conduit through which air from within the space can be drawn. The spraying mechanism includes a pump for delivering liquid from a reservoir to an atomizing nozzle for spraying. The atomizing nozzle is located within the outlet conduit so that atomized particles emitted by the atomizing nozzle are entrained in the airstream emitted by the air-blowing mechanism and thereby distributed evenly throughout the space. The control mechanism controls operation and is adapted to commence operation of the air-blowing prior to operation of the atomizing nozzle and to continue operation of the air-blowing after operation of the nozzle has ceased.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a mist-spraying apparatus primarily but not exclusively for use in an enclosed space.

### BACKGROUND OF THE INVENTION

The aim of the invention is to provide a “dry” mist which can sanitize exposed surfaces within an enclosed space without wetting them. The applications of such an apparatus are varied, but the present invention has been designed primarily for use in the sanitization of exposed surfaces within an enclosed space that may be a storage area, a room or the like. For example, such a space may comprise the interior of goods and delivery vehicles, typically those which are used to transport items, such as hospital laundry and the like. When such laundry is transported it is common for the same vehicle to be used to pick up dirty laundry at the same time as delivering clean laundry. In such circumstances, the opportunity for cross-contamination to occur is great. Even when dirty laundry is not housed within the same vehicle interior as clean laundry, the same vehicle is often used to transport both at separate times so that it is still advantageous for a means to be provided that can sanitize the interior of the vehicle between trips.

Similar requirements exist in other fields. For example, operating rooms are in constant use and whilst new sterile packs of instruments and linen are used for each patient, the surfaces within the operating room itself are not normally sanitized between operations. As many operations cause spillage of blood and other body fluids, the sanitization of exposed surfaces within the operating room between operations would be highly desirable.

Commercial glasshouses and battery hen-houses and the like also need to be sanitized regularly, and a mist-spraying apparatus is often used to spray biocides of various kinds within these structures.

In all of these applications it is a desirable requirement that the mist being sprayed reaches all parts of the enclosed space so that every exposed surface within the space can be treated.

It is therefore an object of the present invention to provide a mist spraying apparatus that can be used for sanitizing an enclosed space and that will substantially fulfill the aforesaid requirement.

### BRIEF SUMMARY OF THE INVENTION

According to the present invention there is provided a mist spraying apparatus primarily but not exclusively for use in an enclosed space comprising an air-blowing means with an outlet conduit through which air can be blown into the space and an inlet conduit through which air from within the space can be drawn for blowing through the outlet conduit to circulate within the space. A spraying means comprises a pump for delivering liquid from a reservoir to an atomizing nozzle for spraying the liquid into the space in the form of an atomized mist, the atomizing nozzle being located within the outlet conduit so that atomized particles emitted by the atomizing nozzle are entrained in the airstream emitted by the air-blowing means and thereby distributed evenly throughout the space. A control means controls operation of the air-blowing means, and the spraying means is adapted to commence operation of the air-blowing means prior to operation of the atomizing nozzle and to continue operation of the air-blowing means after operation of the nozzle has ceased in order to continue circulation of the air and any atomized particles entrained therein around the space for a predetermined period of time.

Hence, in the present invention the air-blowing means is used to create an airstream in the space which immediately entrains the atomized particles being emitted by the atomizing nozzle. As a result the particles are rapidly diluted but also evenly distributed into the airstream and are thus applied evenly over all exposed surfaces within the space being sprayed. Circulation of the air before the atomizing nozzle's operation ensures that the particles emitted by the nozzle are always entrained as atomized particles and do not clump together to form droplets, which are wetting and tend to fall uselessly to the floor of the space. Likewise, re-circulation of the air after operation of the nozzle has ceased ensures that all surfaces within the space are reached by the airstream. It will be appreciated that the length of time that the nozzle operates and that the air is re-circulated after nozzle operation has ceased will depend on the nature and concentration of the liquid being sprayed, the size of the enclosed space and the particular application of the apparatus and can be varied as required.

Preferably, the atomizing nozzle is located centrally within the outlet conduit.

Preferably also, the outlet conduit has a rectangular cross-sectional profile.

Preferably also, the outlet conduit defines a slot so that the airstream emitted into the space is in the form of a slot-jet.

Preferably also, the atomizing nozzle is inset within the outlet conduit.

Preferably also, the spraying tip of the nozzle is inset by at least 25 mm and by no more than mm into the outlet conduit.

Preferably also, the air-blowing means is provided with a source of steam whereby steam is additionally blown into the enclosed space through the outlet conduit.

Preferably also, the atomizing nozzle comprises a 60° solid cone nozzle.

Preferably also, the spraying means is adapted is adapted to spray at least 11 liters of liquid per hour at a pressure of 7×10⁵ N per m² (7 bar).

Preferably also, the air-blowing means comprises a cylindrical fan.

Preferably also, the apparatus is located in proximity to the ceiling at the top of a wall of the enclosed space.

### BRIEF DESCRIPTION OF THE SEVERAL VIEWS OF THE DRAWINGS

The present invention will now be described by way of example with reference to the accompanying drawings.

FIG. 1 is a schematic view of a diagram of a mist-spraying apparatus according to the present invention.

FIG. 2 is a perspective view of the exterior of apparatus as shown in FIG. 1 when mounted within the storage area of a delivery vehicle.

### DETAILED DESCRIPTION OF THE INVENTION

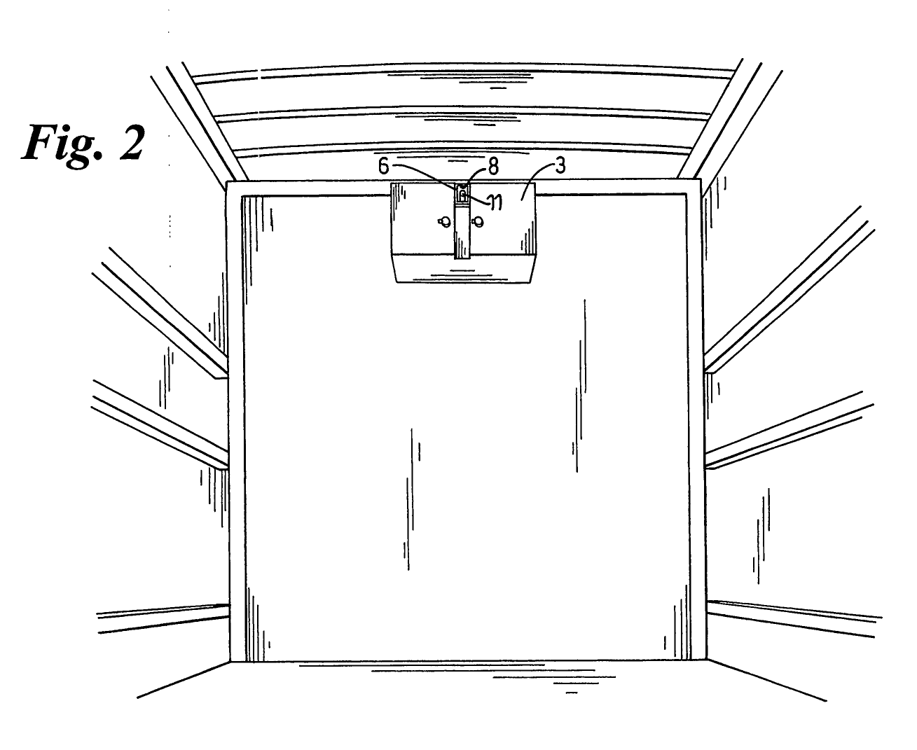

A mist-spraying apparatus in accordance with the invention comprises an air-blowing means and a spraying means 2. Preferably, as shown in FIG. 2, the apparatus is adapted to be located within a housing 3 that can be mounted at a suitable site within an enclosed area, as partially shown in FIG. 2 and as further described below, and connected to a power source. Apparatus that is intended to be used within a vehicle can be adapted to be powered by the vehicle itself by being linked to the vehicle's batteries.

Alternatively, it can be provided with its own battery power supply which is adapted to be re-charged when the vehicle is in motion. Alternatively, apparatus for use in buildings and other permanent or semi-permanent structures can be powered from a main electricity supply.

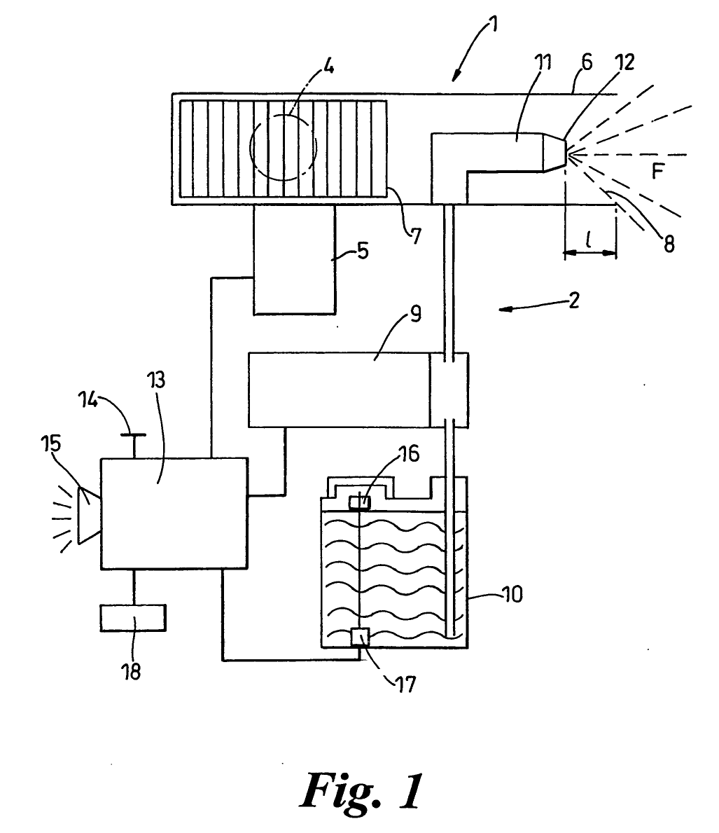

With particular reference to FIG. 1, the air blowing means comprises a fan 4 powered by a motor 5 and defines an outlet conduit 6 through which air can be blown into the space and an inlet conduit 7 covered by a grille through which air from within the space can be drawn for blowing through the outlet conduit 6 to circulate within the space. The fan 4 is preferably a cylindrical fan but any suitable blowing means can be employed. For example, a cylindrical fan which is 130 mm across is capable of delivering an airflow of between 1.4 and 1.7 m³ per minute, which is suitable for use in an average-sized vehicle storage space with approximate dimensions of 12 m by 3 m by 3 m (40′×10′×10′).

The outlet conduit 6 is located at the front of the housing 3 and it has been found that an outlet conduit 6 with a rectangular cross-sectional profile provides an airflow pattern that is better at reaching all corners and exposed surfaces within spaces which are rectangular, parallelepipedal spaces than the airflow pattern provided by a circular outlet conduit. The outlet conduit 6 therefore defines a slot 8 so that the airstream emitted into the space is in the form of a slot-jet. The slot 8 preferably has dimensions of 85 mm by 70 mm when used to deliver an airflow as detailed above within the storage area of a delivery vehicle which is long and narrow, as shown in FIG. 2. In this case the slot 8 is orientated with its longer sides vertical but these sides can be disposed horizontally for enclosed spaces which are wider than they are high. Also, the apparatus is preferably located in proximity to the ceiling at the top of a wall of the enclosed space, as shown in FIG. 2. This enables the apparatus to mist-spray the space effectively.

The spraying means 2 comprises a pump 9 for delivering liquid from a reservoir 10 to an atomizing nozzle for spraying the liquid into the space in the form of an atomized mist. The atomizing nozzle is located within the outlet conduit 6 so that atomized particles emitted by the atomizing nozzle are entrained in the airstream emitted by the fan and thereby distributed evenly throughout the space. In order to obtain the most efficient dispersal of the atomized particles within the airstream, the atomizing nozzle is located centrally within the outlet conduit 6 and preferably its spraying tip 12 is inset therein. It has been found that the spraying tip 12 should be inset by a distance 1 at least 25 mm but no more than 40 mm into the outlet conduit 6 to ensure that the atomized particles emitted therefrom are all entrained in the most efficient manner in the airstream. Also, the atomizing nozzle preferably comprises a 60° solid cone nozzle. Typically, such a spraying means should be capable of spraying at least 11 liters of liquid per hour at a pressure of 7×10⁵ per m² (7 bar). Such a spraying rate is suitable for use in a vehicle storage space as detailed above.

A control means 13 is provided for controlling operation of the air-blowing means and the spraying means 2 and is adapted to commence operation of the fan prior to operation of the atomizing nozzle and to continue operation of the fan after operation of the nozzle 11 has ceased. This continues circulation of the air and any atomized particles entrained therein around the space for a predetermined period of time, which may be several minutes, dependent on the size of the enclosed space being treated.

This arrangement has two advantages. First, when an atomizing nozzle is operated, the pump 9 switches on and during an very short initial period the pressure of the liquid being discharged by the nozzle 11 rises to a predetermined substantially constant level. During the period of time wherein the pressure is rising, the nozzle 11 tends to discharge liquid particles that are not fully atomized. However, these particles can be broken up and entrained fully into the airstream flowing past the nozzle 11 if the airstream has been established prior to operation of the nozzle. Likewise, when the pump 9 is switched off, the nozzle tends to discharge liquid particles but again these can be broken up and entrained within the airstream if the airstream is continued at a constant level for a predetermined time thereafter.

Second, continuing to re-circulate the air along with entrained particles within the space for a predetermined period even after the nozzle has ceased operation, ensures that all exposed surfaces within the space are reached by the airstream and can be acted upon by the sprayed liquid.

The control means 13 is provided with an emergency stop button 14 for use in the unfortunate event that the apparatus is remotely operated whilst a person is trapped within the space. To reduce the chances of such an occurrence, the control means 13 is preferably provided with an audible alarm 15 which sounds continuously during operation of the apparatus. In addition, the control means 13 can be linked to locks on the doors of the space to prevent them being opened whilst the apparatus is in use.

In order to ensure that the reservoir 10 is always adequately filled with liquid to be sprayed, a float 16 is provided within the reservoir 10 and used to trigger an alarm by making electrical contact with, for example, a block 17 located at the base of the reservoir 10 and linked to the control means. When the level of the liquid in the reservoir becomes low, a flashing light, for example, or other alarm means can be triggered by the control means 13 to warn operatives that the reservoir 10 should be topped up.

The control means 13 can also incorporate or be linked to a recording means 18 which records the time and duration of each operation of the apparatus so that checks can be run to ensure that operatives are using the apparatus appropriately and adequately.

It will be appreciated that the apparatus as described herein can be readily adapted for use in various applications. The liquid being sprayed can also vary as required. For example, when spraying soiled laundry, the liquid can comprise a sanitizing liquid including biocides and disinfectants. Alternatively, if used for mist-spraying in glasshouses, the liquid may comprise a pesticide, fungicide, and/or a foliar feed. Preferably, however, the liquid being sprayed comprises a mixture of an oil and aqueous solution. Such a solution produces a more finely atomized spray that an aqueous solution alone. Hence, an oil, for example in the form of a monopropylene glycol or monoethylene glycol, should be added to the liquid advantageously in a quantity of less than part oil to every 100 parts aqueous solution by volume.

In a modification of the above apparatus for particular use in a hospital operating room or an enclosed space wherein it is desired not only to sanitize exposed surfaces but also to treat air-borne particles, the air-blowing means can be supplied with steam from a suitable source so that steam is additionally blown into the enclosed space. Other gaseous substances could also be supplied to the apparatus for spraying into the enclosed space along with or in place of the steam as appropriate for any particular use of the apparatus.

I claim:

1. A mist-spraying apparatus for use in an enclosed space, the apparatus comprising
an air-blowing means with an outlet conduit through which air can be blown into the enclosed space and an inlet conduit through which air from within the enclosed space can be drawn for blowing through the outlet conduit to circulate within the space;
a spraying means comprising a pump for delivering liquid from a reservoir to an atomizing nozzle for spraying the liquid into the space in the form of an atomized mist, the atomizing nozzle being located within the outlet conduit so that atomized particles emitted by the atomizing nozzle are entrained in an airstream emitted by said air-blowing means and thereby distributed evenly throughout the space; and
a control means for controlling operation of the air-blowing means and the spraying means, said control means adapting to commence operation of the air-blowing means prior to operation of the atomizing nozzle and to continue operation of the air-blowing means after operation of the nozzle has ceased in order to continue circulation of the air and any atomized particles entrained therein around the space for a predetermined period of time.

2. An apparatus as claimed in claim 1, wherein said atomizing nozzle is located centrally within said outlet conduit.

3. An apparatus as claimed in claim 1, wherein said outlet conduit has a rectangular cross-sectional profile.

4. An apparatus as claimed in claim 1, wherein said outlet conduit defines a slot so that the airstream emitted into the space is formed of a slot-jet.

5. An apparatus as claimed in claim 1, wherein said atomizing nozzle is inset within said outlet conduit.

6. An apparatus as claimed in claim 1, wherein a spraying tip of the atomizing nozzle is inset by at least 25 mm and by no more than 40 mm into said outlet conduit.

7. An apparatus as claimed in claim 1, wherein the air-blowing means is provided with a source of steam whereby steam is additionally blown into the enclosed space via said outlet conduit.

8. An apparatus as claimed in claim 1, wherein said atomizing nozzle comprises a 60° solid cone nozzle.

9. An apparatus as claimed in claim 1, wherein said spraying means is adapted to spray at least 11 liters of liquid per hour at a pressure of 7×10⁵N per m² (7 bar).

10. An apparatus as claimed in claim 1, wherein said air-blowing means comprises a cylindrical fan.

11. An apparatus as claimed in claim 1, being located in proximity to a ceiling at a top of a wall of the enclosed space.

12. A mist-spraying apparatus as claimed in claim 1, wherein said reservoir contains a mixture of an oil and an aqueous solution.

13. A mist-spraying apparatus as claimed in claim 12, wherein said oil comprises monopropylene glycol or monoethylene glycol.

14. A mist-spraying apparatus as claimed in claim 12, wherein the mixture comprises less than 1 part oil to every 100 parts aqueous solution by volume.
